(19) United States
(12) Patent Application Publication
(10) Pub. No.: US 2005/0141404 A1
(43) Pub. Date: Jun. 30, 2005

(54) Information recording medium and method and apparatus for information reproducing

(75) Inventors: Yasuaki Ootera, Kawasaki-shi (JP); Naoki Morishita, Yokohama-shi (JP); Seiji Morita, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/012,070

(22) Filed: Dec. 15, 2004

(30) Foreign Application Priority Data
Dec. 26, 2003 (JP) 2003-434918

(51) Int. Cl. G11B 7/24; G11B 5/09

(52) U.S. Cl. 369/275.4; 369/47.27

(57) ABSTRACT

In an optical disk according to the present invention, “(G/T)×W” is specified in such a manner that a difference between a peak level and a noise level obtained from frequency characteristics of a doubled reproduction signal obtained by doubling a reproduction signal corresponding to reflected light beams acquired from application of light beams with a predetermined wavelength on a groove is maintained at not less than 19 dB as a result of evaluating the doubled reproduction signal by using the frequency characteristics of the doubled reproduction signal, wherein T (nm) is a central distance between the grooves, G (nm) is a width of the groove, and W (nm) is an amplitude of a wobble of the groove.

### CROSS-REFERENCE TO RELATED APPLICATIONS

This application is based upon and claims the benefit of priority from prior Japanese Patent Application No. 2003-434918, filed Dec. 26, 2003, the entire contents of which are incorporated herein by reference.

### BACKGROUND OF THE INVENTION

1. Field of the Invention

The present invention relates to an information recording medium such as an optical disk, and more particularly to a direct read after write optical disk using an organic dye film for a recording film, and relates to a method and an apparatus for information recording.

2. Description of the Related Art

As optical disks as information recording mediums, there are a reproduction-only optical disk as typified by a CD or a DVD-ROM, a write-once read-many optical disk as typified by a CD-R or a DVD-R, a rewritable optical disk as typified by a CD-RW, a DVD-RAM or a DVD-RW which can be utilized in an external memory for a computer or a recording/reproducing video machine, and others.

Of the above-described optical disks conforming to various standards, in the write-once read-many optical disk, a groove (guide groove) formed on the optical disk is wobbled and address information is provided to the groove.

Many of the direct read after write optical disks consist of a structure in which an organic dye film with a predetermined thickness is deposited in a groove previously formed when molding the disk.

However, it is known that an effective depth or a width of a groove is apt to fluctuate because an organic dye film enters the groove, resulting in a groove wobble signal leaking into a recording data portion, which generates an error.

Jpn. Pat. Appln. KOKAI Publication No. 2003-173577 proposes that a proportion of a wobble amplitude Wo and a push-pull amplitude PP (Wo/PP) falls within a range of 0.1≦Wo/PP≦0.4 and, assuming that d1 (10⁻¹⁰ m) is a recording layer depth and m (T) is a wobble frequency, 1200≦d1×m≦160000 is satisfied.

However, in a direct read after write optical disk which is used based on a standard in which a wavelength of laser beams used for recording is reduced to approximately 400 nm (reduction in diameter of a condensing spot diameter) for the purpose of increasing a recording density, since a track pitch is more dense than that corresponding to a conversion of the wavelength, there is a problem that a quantity of leak of the wobble signal to an adjacent groove is greatly increased.

Further, since a sensitivity of a dye which is sensitive with respect to laser beams with a wavelength of 400 nm is lower than that of a dye used in a disk based on a current DVD standard, an optimum value of a groove width becomes narrower than that of the direct read after write optical disk based on the DVD standard. Therefore, it is difficult to obtain a sufficient tracking signal (push-pull signal) amplitude, which lowers the signal-to-noise ratio.

It is to be noted that this problem cannot be improved even if the method described in Jpn. Pat. Appln. KOKAI Publication No. 2003-173577 is used.

### BRIEF SUMMARY OF THE INVENTION

According to an aspect of the present invention there is provided an information recording medium comprising:
a recording film which includes an organic dye material with which information can be recorded when applied with light beams having a predetermined wavelength; a substrate which holds the recording film together with a guide groove with a wobble which is used to guide the light beams having the predetermined wavelength; a reflection film which is provided with a predetermined thickness on a side opposite to the substrate side of the recording film; and a second substrate which is appressed against the reflection film through a bonding layer,
wherein the following expression is satisfied:
   3<(G/T)×W<27
   wherein T (nm) is a central distance between the guide grooves, G (nm) is a width of the guide groove, and W (nm) is an amplitude of the wobble of the guide groove.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view illustrating an example of an optical disk to which an embodiment according to the present invention is applied;

FIG. 2 is a schematic view illustrating a wobble groove formed on a recording surface of the optical disk depicted in FIG. 1;

FIG. 3 is a schematic view illustrating a relationship between a reproduction signal and noises from the wobble groove on the optical disk depicted in FIG. 2;

FIG. 4 is a schematic view illustrating an example of an evaluation device which evaluates a state of the wobble of the optical disk depicted in FIGS. 1 and 2;

FIG. 5 is a schematic view illustrating a “sum signal” obtained based on reflected light beams from the wobble groove in the evaluation device depicted in FIG. 4;

FIG. 6 is a schematic view illustrating a “difference signal” obtained based on reflected light beams from the wobble grove in the evaluation device shown in FIG. 4;

FIG. 7 is a schematic view illustrating an example of an address signal processing portion utilized in the evaluation device shown in FIG. 4;

FIG. 8 is a schematic view illustrating an example of a measurement portion utilized in the evaluation device shown in FIG. 4;

FIG. 9 is a schematic view illustrating an example of frequency characteristics of a wobble signal having a single frequency obtained by the evaluation device shown in FIG. 4;

FIG. 10 is a schematic view illustrating an example of frequency characteristics of a doubled wobble signal obtained by doubling an unmodulated wobble signal with a single frequency obtained by the evaluation device shown in FIG. 4;

FIG. 11 is a schematic view illustrating frequency characteristics of the doubled wobble signal obtained by doubling a binary-phase-modulated wobble signal having a phase difference between codes of approximately 180 degrees obtained by the evaluation device shown in FIG. 4;

FIG. 12 is a schematic view illustrating frequency characteristics of a doubled wobble signal obtained by doubling a partially modulated wobble signal acquired by the evaluation device shown in FIG. 4;

FIG. 13 is a schematic view illustrating an example of steps to manufacture an optical disk to which an embodiment according to the present invention is applied.

### DETAILED DESCRIPTION OF THE INVENTION

An embodiment according to the present invention will now be described in detail hereinafter with reference to the accompanying drawings.

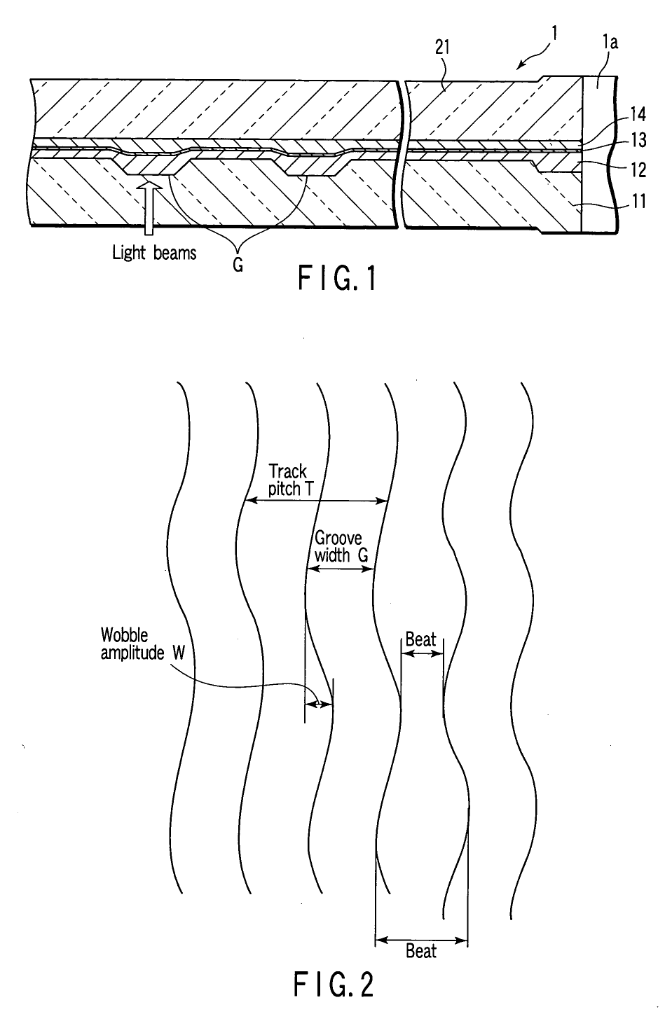

As shown in FIG. 1, an optical disk 1 as a recording medium includes a first transparent substrate 11, a second transparent substrate 21 provided to be opposed to the first transparent substrate, a recording layer 12, a reflection layer 13 and a bonding layer 14 layers of which are provided between the both substrates in the mentioned order from the first transparent substrate 11 side. It is to be noted that a central hole 1a having a diameter of 15 mm is formed at the center of the optical disk 1, i.e., the first and second substrates. Further, a diameter of each of the substrates 11 and 21 is 120 mm, a thickness of the same is approximately 0.6 mm, and a total thickness of the disk 1 including the recording layer 12, the reflection layer 13 and the bonding layer 14 is approximately 1.2 mm.

A groove (guide groove) 11a which will be described below with reference to FIG. 2 is formed on a surface of the first substrate 11 on the recording layer 12 side. It is to be noted that the groove 11a has, e.g., a spiral shape with an origin at the central hole 1a, and a distance between adjacent grooves is formed into a wobble shape which varies in a predetermined cycle.

A diazo-based or phthalocyanine-based organic dye material is formed with a predetermined thickness to the recording layer 12.

For example, Al or Ag is formed with a predetermined thickness to the reflection layer 13 by a technique such as sputtering.

The bonding layer 14 is, e.g., an ultraviolet curing adhesive which is hardened when applied with ultraviolet rays (UV rays), and it can be arbitrarily selected from resins having the viscosity of, e.g., approximately 300 to 5000 CPS.

The second substrate 15 is, e.g., molded with respective steps to manufacture the groove 11a, the recording layer 12 and the reflection layer 13 being eliminated from steps to produce the first substrate 11, and a transparent resin plate formed to have a predetermined thickness in advance has a discoid shape by press working or the like. A label area in which character information, a photograph or the like can be printed may be formed on a surface of the second substrate 15 opposite to the bonding layer 14 according to needs.

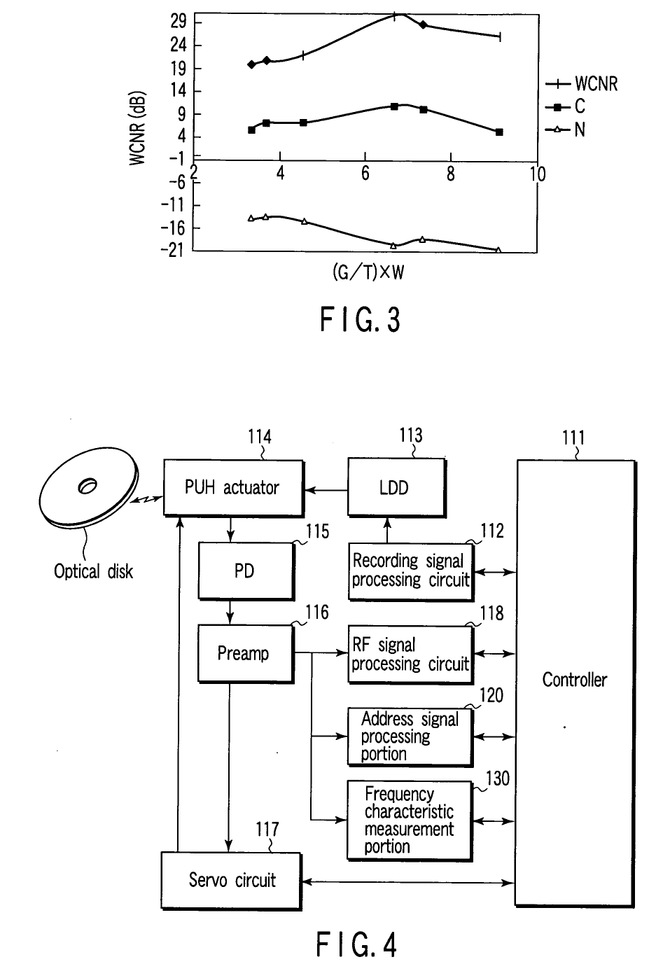

It is to be noted that a gap between grooves 11a formed on a first substrate 11 in a radial direction of an optical disk 1 will be described below with reference to FIG. 3, but it is approximately 400 nm (central value, which will be referred to as a track pitch T hereinafter). Furthermore, the groove 11a is wobbled in a predetermined cycle as described above, and its amplitude (wobble amplitude) is specified with respect to, e.g., the track pitch T in such a manner that “(G/T) W” falls within a range mentioned below with reference to FIG. 3,

wherein

W (nm) is a wobble amplitude,
G (nm, a measuring method will be described later) is a width of the groove 11a, and
T is a track pitch.

Meanwhile, as apparent from FIG. 2, it is known that, when the groove formed into a spiral shape is set to have a wobble shape, a gap between the grooves fluctuates due to the periodicity of phases of wobble amplitudes of adjacent grooves. It is to be noted that a level at which the gap between the grooves varies based on the wobble amplitude is called a beat.

This increases a cross talk (reduction in a signal-to-noise ratio) which is a leak of a signal with which address information recorded in an adjacent groove is reproduced at a (spiral) position where a distance between adjacent grooves becomes narrow when reading the address information previously formed in the wobble-shaped groove.

Although the leak of information recorded in an adjacent groove can be suppressed to some extent by narrowing a groove width G, the amplitude of a push-pull signal utilized as a tracking error signal becomes very small.

Based on this, since out-of-tracking tends to occur when the groove width G is narrowed in order to avoid the influence of the beat, reduction of the groove width G is limited. Incidentally, it is needless to say that the tracking error signal is apt to be buried in noises when the groove width G becomes narrow.

On the other hand, when the wobble amplitude W is changed, a relationship between a wobble signal intensity and the leak from an adjacent groove varies, but the groove width G and the wobble amplitude W have a trade-off relationship. Therefore, even if one of these factors can be optimized, it is hard to optimize both of them.

Thus, as shown in FIG. 3, T nm is a track pitch (central value of a distance between grooves), G nm is a groove width, W nm is a wobble amplitude. Further, in regard to WCNR (wobble signal intensity-to-noise ratio) when (G/T)×W is changed, the track pitch T is fixed to 400 nm, the groove width G is changed to 190 nm and 260 nm, and the wobble amplitude W is changed to 7 nm and 14 nm. In an optical disk manufactured by way of trial with the above-described values in which an object lens having a numerical aperture NA of 0.65 is used, when a reproduction signal is obtained by a tester in which a wavelength λ=405 nm is determined, it can be understood that a reproduction output not less than 19 dB, which is determined as a lower limit of WCNR, can be obtained in the following range:
3<(G/T)×W<9

Furthermore, with a margin, it is realized that a reproduction output which enables 24 dB or above of WCNR can be obtained in the following range:
5<(G/T)×W<9

Moreover, for example, even when a recording device and a reproduction device differ, a range, in which a reproduction output which is not smaller than, e.g., 26 dB of WCNR, can be obtained as a range with which the signal can be assuredly reproduced, the following expression holds:
6<(G/T)×W<8

In this connection, when the groove width G is specified at a substantially central part of the groove G in the depth direction, the fact that a relationship between the groove width G and a width of a non-groove area becomes larger than approx. 1:1 (groove width G is ½ of the track pitch T) can be ignored when forming the disk and, on the other hand, a groove width of approx. ⅓ of the track pitch T is acceptable. Therefore, in “G/T=½”, a range in which WCNR mentioned above can be a reproduction output larger than 19 dB is as follows:
6<(G/T)×W<18
Likewise, in “G/T=⅓”, the following can be obtained:
9<(G/T)×W<27

Therefore, based on a calculation, a range of “(G/T)×W” which can obtain a reproduction signal with which WCNR remains not lower than 19 dB is as follows:
6<(G/T)×W<27

Additionally, based on the calculation, it can be recognized that a range which can obtain a reproduction output with which WCNR is not less than 26 dB is as follows:
9<(G/T)×W<18

As described above, in an optical disk in which an organic dye film is used as a recording layer on a substrate to which a groove having the wobble is formed in advance, assuming that T nm is a track pitch, G nm is a groove width and W nm is a wobble amplitude, and, taking the influence of the beat of the wobble amplitude into consideration, a reproduction output which is not smaller than 19 dB as a lower limit of WCNR can be obtained in the following range:
3<(G/T)×W<27

Further, preferably, an excellent reproduction signal can be obtained in the following range:
6<(G/T)×W<27

Furthermore, even when a recording device differs from a reproduction device, a reproduction signal can be assuredly obtained by maintaining the groove width G, the track pitch T and the wobble amplitude W with the following range:
9<(G/T)×W<18

In this manner, by setting and associating the groove width G, the track pitch T and the wobble amplitude W, a signal intensity can be assured, while the leak of the wobble signal from an adjacent groove can be avoided. Incidentally, it is preferable that a gap between grooves defined by conditions, i.e., the track pitch T, is narrower than a spot diameter when laser beams for recording/reproduction from a non-illustrated recording/reproduction device are condensed.

Moreover, as to the groove width G which can stabilize the tracking, an optical disk which enables the stable track control can be obtained by setting each parameter in such a manner that “(G/T)×W” takes a numerical value in the above-described range.

It is to be noted that WCNR of the groove G including the above-described wobble amplitude W can be evaluated by an evaluation device which will be explained below with reference to, e.g., FIG. 4.

An evaluation device 101 includes a controller 111, a recording signal processing circuit 112, a laser drive circuit 113, a pickup head 114, a photodetector 115, a preamplifier 116, a servo circuit 117, an RF signal processing circuit 118, an address signal processing portion 120, a measurement portion 130 and others.

It is to be noted that the evaluation device 101 can be readily configured by additionally providing the measurement portion 130 in, e.g., a general optical disk device, and it is sufficient to add, e.g., a low-noise eliminator/amplifier 131, a band pass filter 132, a multiplication circuit (doubling circuit) 133, a frequency characteristic measurement circuit (spectrum analyzer) 134 and others.

That is, an output from the preamplifier 116 is input to the low-noise eliminator/amplifier 131 of the measurement portion 130, and an output from the frequency characteristic measurement circuit 134 is input to the controller 111, thereby enabling evaluation described below.

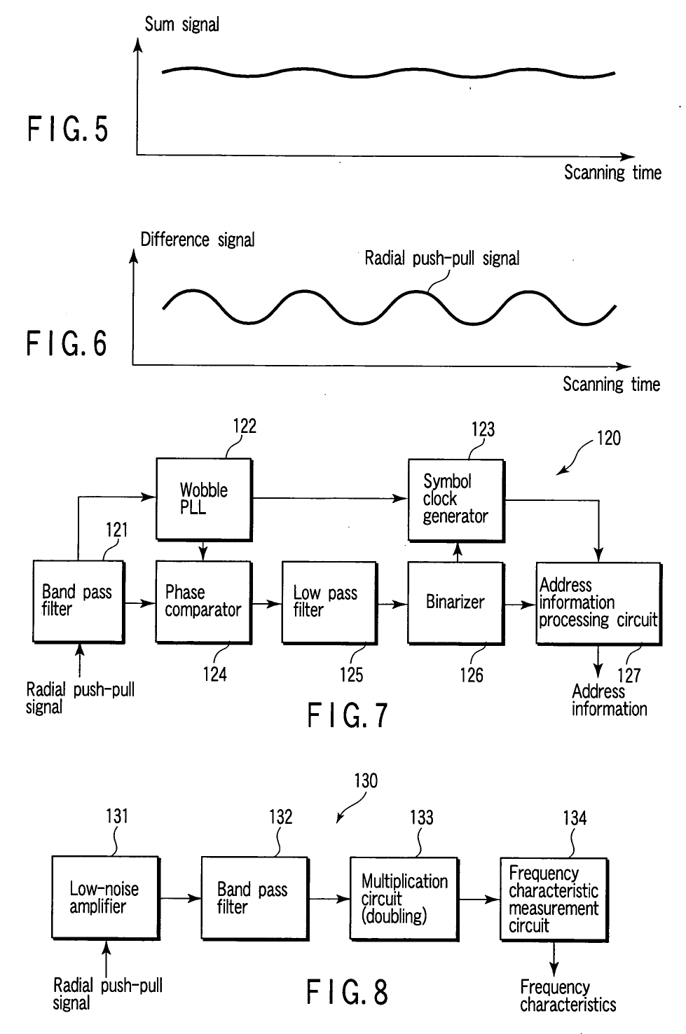

For example, it is sufficient to apply laser beams emitted from the PUH 114 on an information recording layer of an optical disk (evaluation target) having a groove with such a wobble as shown in FIG. 2, capture the reflected laser beams from the optical disk including a modulation component based on information prerecorded in the wobble groove inherent to the optical disk by the PUH 114, then lead the laser beams to the PD 115, and input an electric signal outputted from the PD 115 to the measurement portion 130 described before. It is to be noted that a known 4-split detector or the like can be used as the PD 115. Further, since there is known a method for obtaining a “sum signal” such as shown in FIG. 5 and a “difference signal” such as shown in FIG. 6 based on output signals obtained from individual detection areas of the 4-split detector, the detailed explanation will be eliminated.

It is to be noted that the “difference signal” shown in FIG. 6 is a radial push-pull signal which is processed in the present invention. Furthermore, since the radial push-pull signal alone varies in accordance with the wobble, this is called a wobble signal, as described above.

Giving a brief description on a process to generate a signal guided to the measurement portion 130, four electrical signals output from the PD 115 are amplified by the preamplifier 116, and output to the servo circuit 117, the RF signal processing circuit 118 and the address signal processing portion 120.

The servo circuit 117 generates servo signals such as a focus signal, a tracking signal, a tilt signal or the like based on the electrical signal detected by the PD 115 in relation to each of the recording surface and the groove of the object lens which is not described in detail and the evaluation target (optical disk), and outputs each servo signal to each of non-illustrated focus, tracking and tilt actuators of the PUH 114, thereby setting a positional relationship between the recording surface and the groove of the object lens and the optical disk in a predetermined range.

The RF signal processing circuit 118 reproduces information or the like recorded on the optical disk by mainly processing the sum signal (see FIG. 5) of the electrical signals detected by the PD 115.

The address signal processing portion 120 reads physical address information indicative of a recording position on the optical disk by processing the electrical signal detected by the PD 115, and outputs a result to the controller 111. It is to be noted that the address signal processing portion 120 includes, e.g., a band pass filter 121, a wobble PLL 122, a symbol clock generator 123, a phase comparator 124, a low pass filter 125, a binarizer 126, an address information processing circuit 127 and the like as shown in FIG. 7, and reads management information of the physical address information or the like reflected to the wobble groove from the radial push-pull signal supplied from the PD 115.

FIG. 8 is a view showing frequency characteristics of the wobble signal having the unmodulated single frequency. The frequency characteristics have a peak in a carrier frequency (f₁) of the wobble signal, and any other parts correspond to noise components. As shown in FIG. 8, the NBSNR (or WCNR) can be measured by obtaining a difference between a peak value and a noise level.

In the present invention, in order to accurately measure the WCNR of the above-described wobble signal, a doubled WCNR is defined. This doubled WCNR is a difference between the peak value and the noise level which appears in a frequency which is twofold the wobble carrier frequency from the frequency characteristics acquired by doubling the wobble signal.

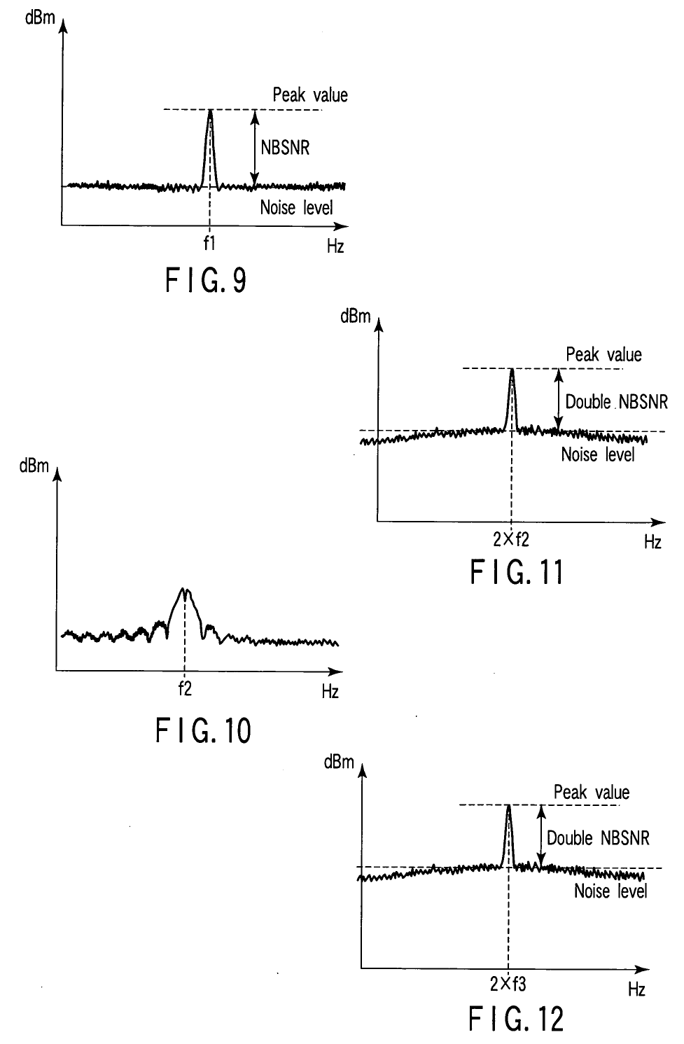

FIG. 9 is a view showing frequency characteristics of a doubled wobble signal obtained by doubling the wobble signal having the unmodulated single frequency. FIG. 10 is a view showing frequency characteristics of the doubled wobble signal obtained by doubling a wobble signal subjected to binary phase modulation whose phase difference between codes is approximately 180 degrees. FIG. 11 is a view showing frequency characteristics of a doubled wobble signal obtained by doubling a partially modulated wobble signal.

It can be understood from FIGS. 9, 10 and 11 that the doubled wobble signal has the simple frequency characteristics having only one peak at 2×f₁, 2×f₂ and 2×f₃, respectively.

That is because a carrier component alone of the wobble signal is extracted by doubling the wobble signal.

Therefore, a difference between the peak value and the noise level which appears in the frequency which is twofold the carrier frequency in the frequency characteristics after the doubling processing is acquired as the doubled WCNR, and this doubled WCNR is evaluated, thereby accurately comprehending the wobble signal.

In more detail, the radial push-pull signal, i.e., the wobble signal output from the preamplifier 116, is input to the low-noise eliminator/amplifier 131 of the measurement portion 130 of the evaluation device 101, and a direct-current component included in the wobble signal is eliminated. Further, the wobble signal is amplified to a predetermined level by the amplifier 131.

Excessive frequency components are eliminated from the amplified wobble signal by the band pass filter 132, and this wobble signal is supplied to the multiplication circuit 133. It is to be noted that the excessive frequency components are frequency components which are sufficiently far from the carrier frequency.

The multiplication circuit 133 multiplies the supplied wobble signal, generates, e.g., a doubled wobble signal, and supplies this doubled wobble signal to the frequency characteristic measurement circuit 134.

Therefore, the doubled WCNR is measured by the frequency characteristic measurement circuit 134.

The thus obtained WCNR is a numeric value (dB) described before in connection with FIG. 3.

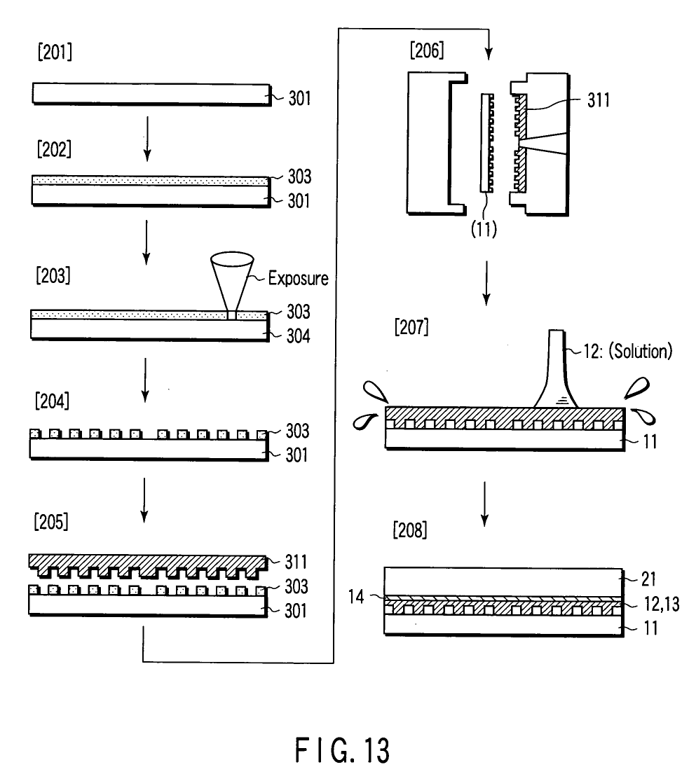

Steps to manufacture the optical disk shown in FIGS. 1 and 2 will now be briefly described with reference to FIG. 13. It is to be noted that the respective steps shown in FIG. 13 are of course associated with an example of the operation of a recording medium manufacturing apparatus for manufacturing recording mediums, except some steps although not described in detail.

First, as shown at a step [201], a glass disc whose surface is polished to a predetermined surface roughness is obtained and then cleansed is prepared as an original disk 301.

Then, as shown as a step [202], a photoresist 303 is applied on the surface of the glass original disk 301, and then exposure is carried out by using laser beams having a predetermined wavelength in order to record physical information (header), a guide groove (irregularities, i.e., a wobble groove) and others. Incidentally, as to the physical information (header) or the guide groove (irregularities, i.e., a wobble groove) recorded at this step, it is needless to say that “(G/T)·W” mentioned above is specified in a predetermined range.

Then, the exposed glass original disk 301 is developed, and an undeveloped part of the photoresist is removed, thereby obtaining irregularities like pits such as shown at a step [204].

Thereafter, as shown at a step [205], the glass original disk 301 obtained at the step [204] is subjected plating processing, thus creating a stamper 311.

Then, as shown at a step [206], a molded resin plate (corresponding to the first substrate 11 shown in FIG. 1) is created by injection molding with the stamper 311 being used as a mold. It is to be noted that, e.g., polycarbonate is used as a substrate material.

Subsequently, as shown at a step [207], an organic dye which can be a recording film (12) is formed to a predetermined thickness on the molded plate (11) corresponding to the first substrate by, e.g., a spin coating method, and it is hardened by a predetermined drying method.

Thereafter, as shown at a step [208], a reflection layer 13 is formed on the recording layer (12), and a substrate corresponding to the second substrate 21 manufactured at different steps is attached thereto by using an adhesive 14, thereby bringing an optical disk to completion.

Incidentally, if the adhesive 14 is, e.g., a UV curing resin which is hardened when applied with ultraviolet rays (UV rays), although not shown, in place of the step [207], a predetermined quantity of the UV curing resin is dropped on the reflection layer 13 of the first substrate in a state that the members are rotated at a predetermined revolving speed by, e.g., a spinner, the second substrate prepared at different steps in advance is set on the first substrate 11 in a state in which the second substrate is facing a direction opposite to the surface on which the UV curing resin is diffused, the adhesive is removed by high-speed revolutions of the spinner (excessive adhesive removing step), and then the ultraviolet rays are applied, thereby bringing the optical disk to completion.

Incidentally, when an inorganic material is used for the recording layer, it is needless to say that the recording layer is formed with a predetermined thickness by, e.g., a sputtering method.

Further, although the description has been given as to the example in which the substrates each having a thickness of 0.6 mm are attached on each other in the foregoing embodiment, it is needless to say that the same advantages can be obtained when a cover layer having a thickness of 0.1 mm is attached on the substrate having a thickness of 1.1 mm, for example.

As described above, according to the present invention, in the direct read after write optical disk which uses as the recording film the organic dye film which is sensitive with respect to blue laser beams in the vicinity of a wavelength of 400 nm and whose recording sensitivity is lower than that of a dye film for a DVD disk, it is possible to obtain an optical disk on which a quantity of dye in the groove is controlled by optimizing the groove width G and information can be readily recorded with a small recording laser power. Incidentally, although “G/T=⅓” shown in FIG. 3 is a groove width which is as small as possible in the current disk manufacturing process, the direct read after write optical disk by which a signal-to-noise ratio (WCNR) is maintained at not less than 19 dB can be obtained by setting each parameter in such a manner that “(G/T)·W” mentioned above falls within a predetermined range.

That is, according to the present invention, it is possible to suppress the reproduction signal from becoming unstable when the groove on the optical disk which uses the organic dye film as the recording film is filled with the dye film.

Furthermore, according to the present invention, even in the direct read after write optical disk which has a narrow track pitch and on which information can be recorded by using light beams with a short wavelength, the influence of the leak of the wobble signal from an adjacent groove can be minimized, thereby optimizing a wobble signal intensity of the corresponding track.

Moreover, according to the present invention, it is possible to manufacture an optical disk which has less leak of the wobble signal from an adjacent groove and can narrow a track pitch, and a high signal quality can be obtained while increasing a recording density. It is to be noted that the present invention is not restricted to the foregoing embodiments, and various modifications or changes can be carried out without departing from the scope of the present invention on the embodying stage. Additionally, the foregoing embodiments can be appropriately combined with each other and embodied as long as possible and, in such a case, advantages can be obtained from these combinations.

1. An information recording medium comprising: a recording film which includes an organic dye material with which information can be recorded when applied with light beams having a predetermined wavelength; a substrate which holds the recording film together with a guide groove with a wobble which is used to guide the light beams having the predetermined wavelength; a reflection film which is provided with a predetermined thickness on a side opposite to the substrate side of the recording film; and a second substrate which is appressed against the reflection film through a bonding layer,
wherein the following expression is satisfied:
3<(G/T)×W<27
wherein T (nm) is a central distance between the guide grooves, G (nm) is a width of the guide groove, and W (nm) is an amplitude of the wobble of the guide groove.

2. The information recording medium according to claim 1, wherein the central distance T between the guide grooves is specified to be narrower than a spot diameter of light beams used for record and reproduction of information.

3. The information recording medium according to claim 1, wherein the guide groove is formed in such a manner that a difference between a peak level and a noise level obtained from frequency characteristics of a doubled reproduction signal obtained by doubling a reproduction signal corresponding to the guide groove acquired from reflected light beams of light beams applied on the guide groove becomes not less than 19 dB when the doubled reproduction signal is evaluated based on the frequency characteristics of the doubled reproduction signal.

4. The information recording medium according to claim 1, wherein the (G/T)×W is satisfied, by
6<(G/T)×W<18.

5. The information recording medium according to claim 4, wherein the guide groove is formed in such a manner that a difference between a peak level and a noise level obtained from frequency characteristics of a doubled reproduction signal obtained by doubling a reproduction signal corresponding to the guide groove acquired from reflected light beams of light beams applied on the guide groove becomes not less than 24 dB when the doubled reproduction signal is evaluated based on the frequency characteristics of the doubled reproduction signal.

6. The information recording medium according to claim 1, wherein the (G/T)×W is satisfied, by
6<(G/T)×W<8.

7. The information recording medium according to claim 6, wherein the guide groove is formed in such a manner that a difference between a peak level and a noise level obtained from frequency characteristics of a doubled reproduction signal obtained by doubling a reproduction signal corresponding to the guide groove acquired from reflected light beams of light beams applied on the guide groove becomes not less than 26 dB when the doubled reproduction signal is evaluated based on the frequency characteristics of the doubled reproduction signal.

8. The information recording medium according to claim 1, wherein a wavelength of light beams utilized for recording or reproduction of information has a central wavelength of 405 nm.

9. The information recording medium according to claim 8, wherein the guide groove is formed in such a manner that a difference between a peak level and a noise level obtained from frequency characteristics of a doubled reproduction signal obtained by doubling a reproduction signal corresponding to the guide groove acquired from reflected light beams of light beams applied on the guide groove becomes not less than 19 dB when the doubled reproduction signal is evaluated based on the frequency characteristics of the doubled reproduction signal.

10. The information recording medium according to claim 8, wherein the guide groove is formed in such a manner that a difference between a peak level and a noise level obtained from frequency characteristics of a doubled reproduction signal obtained by doubling a reproduction signal corresponding to the guide groove acquired from reflected light beams of light beams applied on the guide groove becomes not less than 24 dB when the doubled reproduction signal is evaluated based on the frequency characteristics of the doubled reproduction signal.

11. The information recording medium according to claim 8, wherein the guide groove is formed in such a manner that a difference between a peak level and a noise level obtained from frequency characteristics of a doubled reproduction signal obtained by doubling a reproduction signal corresponding to the guide groove acquired from reflected light beams of light beams applied on the guide groove becomes not less than 26 dB when the doubled reproduction signal is evaluated based on the frequency characteristics of the doubled reproduction signal.

12. An information recording medium comprising: an information recording area in which information is recorded; and a wobble groove which is a groove used to guide light beams on the information recording area and wobbled with a predetermined amplitude in accordance with a frequency whose phase is modulated with a predetermined timing,
wherein “(G/T)×W” is specified in such a manner that a difference between a peak level and a noise level obtained from frequency characteristics of a doubled reproduction signal obtained by doubling a reproduction signal corresponding to reflected light beams acquired from application of light beams with a predetermined wavelength on the groove becomes not less than 19 dB as a result of evaluating the doubled reproduction signal by using the frequency characteristics of the doubled reproduction signal, wherein T (nm) is a central distance between the grooves, G (nm) is a width of the groove, and W (nm) is an amplitude of a wobble of the groove.

13. The information recording medium according to claim 12, wherein a wavelength of light beams utilized for recording or reproduction of information has a central wavelength of 405 nm.

14. An apparatus for reproducing information comprising:
pickup unit which emits a laser light;
photodetector which detects the laser light reflected from an information recording medium and outputs a signal corresponding to an intensity of the laser light reflected from an information recording medium; and
address signal processing section which determines a physical address information indicative of a recording position on the information recording medium with respect to the signal output from the photodetector.

15. The apparatus according to claim 14, wherein
the address signal processing section reads management information of the physical address information.

16. A method for reproducing information comprising:
detects the laser light reflected from an information recording medium by using photodetector; and
determines a physical address information indicative of a recording position on the information recording medium by using of the signal output from the photodetector.

17. The method according to claim 16, wherein
the physical address information includes management information of the physical address information.
